(19) United States
(12) Patent Application Publication
(10) Pub. No.: US 2011/0320276 A1
(43) Pub. Date: Dec. 29, 2011

(54) SYSTEM AND METHOD FOR ONLINE MEDIA RECOMMENDATIONS BASED ON USAGE ANALYSIS

(75) Inventors: Bonnie K. Ray, Nyack, NY (US); Pei Sun, Beijing (CN); Jing Min Xu, Beijing (CN)

(73) Assignee: INTERNATIONAL BUSINESS MACHINES CORPORATION, Armonk, NY (US)

(21) Appl. No.: 12/824,772

(22) Filed: Jun. 28, 2010

(51) Int. Cl. G06Q 30/00

(52) U.S. Cl. 705/14.53

(57) ABSTRACT

An online recommendation system, method and computer program product for recommending on-line item(s) including a recommended a usage for the on-line item(s). The recommendation method includes capturing, for one or more users at a respective client device, usage characteristics of each users' navigation to and use of one or more items, from among a plurality of items of an item set, on-line, via a respective user interface; obtaining corresponding profile information for each respective user, the profile information including user attributes; storing the usage characteristics and corresponding profile information of each of one or more users; and, for a current user navigating online to the set of items: deriving an item usage recommendation for the current online user based on items of the item set navigated to and used by other online users having similar profiles; and, recommending for the current user, via that current user's user interface, an on-line item and its suggested usage from among the set of items.

### BACKGROUND OF THE INVENTION

1. Field of the Invention

The present invention relates to a system and method of providing at least one recommended item and usage for at least one item to an on-line user based on similarities of usage behaviors of the on-line user and other users.

2. Description of Related Art

The enjoyment of particular items is a subjective judgment made by individuals based on any number of criteria, not least of which is the manner in which the item is used. The ability to make acceptable recommendations to a particular person about a given item such as, for example, a book, can be helpful. Such information would enable a person to, e.g., quickly skim a book that is not enjoyable to read in order to extract the key facts, while leisurely perusing an enjoyable book, e.g., rereading some chapters multiple times in order to savor the choice of expressions. There are many critics that rate books. Therefore, an individual can try to identify a critic with somewhat similar preferences as a source for selecting books to read and for suggestions on how best to enjoy a book. However, relying on a critic is not reliable on a regular basis as the critic may not have the same particular likes and dislikes as the reader, and typically the critic provides little indication of the manner in which he read a book.

Prior art systems have attempted to provide recommendations to a user based on, e.g., buying patterns of items or explicit ratings of items provided by the user as compared with other, similar, users. For example, collaborative filtering systems operate generally by asking many users to rate an item that the user is familiar with, and storing these ratings within user-specific rating profiles. To identify items that may be of interest to a particular user, a service correlates the user's rating profile to the profiles of other users to identify users with similar tastes. When applied over large databases of user rated data, this type of analysis can produce recommendations that are valuable to both users and merchants.

However, while collaborative filtering utilizes information obtained through collecting and analyzing an individuals' buying preferences, information on an individual's behaviors in using an item are typically not captured.

Thus one problem with current collaborative filtering is that such information does not provide a means to determine a reader's objectives in reading a particular book. For instance, some books, such as textbooks or reference books, are read primarily to determine certain facts, while novels are typically read from cover to cover to enjoy the story. Such objectives are important in determining other related books to recommend, as well as in determining a suggested reading pattern for a recommended book. Thus current collaborative filtering techniques fail to capture key aspects of how an item is used, which reduce the effectiveness of such techniques in providing accurate recommendations.

### SUMMARY OF THE INVENTION

The present invention addresses these and other problems that are inherent with existing collaborating filtering systems to enable improved on-line recommendations.

In an embodiment there is disclosed a method of providing online recommendations, comprising:

capturing, for one or more users, at a respective client device, usage characteristics of each users' navigation to and use of one or more items, from among a plurality of items of an item set, on-line, via a respective user interface;

obtaining corresponding profile information for each respective user, said profile information including user attributes;

storing said usage characteristics and corresponding profile of each one or more users; and, for a current user navigating online to said set of items:

deriving an item recommendation and associated usage of said item for said current online user based on items of said item set navigated to and used by other online users having similar profiles; and,

recommending for said current user, via that current user's user interface, usage of an on-line item from among said set of items, wherein a programmed processing unit performs one or more said capturing, obtaining and deriving.

In another embodiment there is disclosed a system for providing online recommendations comprising:

a memory;

a processor in communications with the memory, wherein the system performs a method comprising:

capturing, for one or more users at a respective client device, usage characteristics of each users' navigation to and use of one or more items, from among a plurality of items of an item set, on-line, via a respective user interface;

obtaining corresponding profile information for each respective user, said profile information including user attributes;

storing said usage characteristics and corresponding profile information of each of one or more users; and, for a current user navigating online to said set of items:

deriving an item usage recommendation for said current online user based on items of said item set navigated to and used by other online users having similar profiles; and,

recommending for said current user, via that current user's user interface, an on-line item and its suggested usage from among said set of items, wherein a programmed processing unit performs one or more said capturing, obtaining and deriving.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the conception and specific embodiment as a base for designing or modifying the structures for carrying out the same urposes of the present invention and that such other features do not depart from the spirit and scope of the invention in its broadest form.

### BRIEF DESCRIPTION OF THE DRAWINGS

Other aspects, features, and advantages of the present invention will become more fully apparent from the following detailed description, the appended claims, and the accompanying drawings in which similar elements are given similar reference numerals.

FIG. 1 illustrates a block diagram of a collaborative filtering system;

FIG. 2 illustrates method of providing a recommendation of at least one item to a user based on similarity of preferences of the user and other users; and

FIG. 3 is a block diagram of a computer system for use with the present invention.

### DETAILED DESCRIPTION OF THE INVENTION

The following description sets forth an exemplary embodiment, in accordance with the principles of the present invention, of a collaborative filtering system or similar “social” filtering or media recommending system that utilizes attributes of an online user for providing a recommendation of an item within a group of items to the online user based on that user's profile information and similarity of use preferences with use preferences of a similar subgroup of users of the system. For purposes of illustration, the filtering system and associated methods are described herein in the context of recommending a book. It should be understood that the collaborative filtering system is not limited to recommending books. Rather, the collaborative filtering system of the present invention can be used to recommend any product or service whose use can be captured and tracked online, for instance movies or music.

The recommendation system and method of the present invention can be implemented on any suitable internet-connected computer and associated components, peripherals, keyboards, and the like, known to one of ordinary skill in the art. Profile information for a user is provided to the system in a suitable fashion. For example, each user can enter data into a database by keyboard, touch screen, voice, or other means. Usage information is captured via the internet through collection of attributes such as time spent on a page, total time spent with book open, etc.

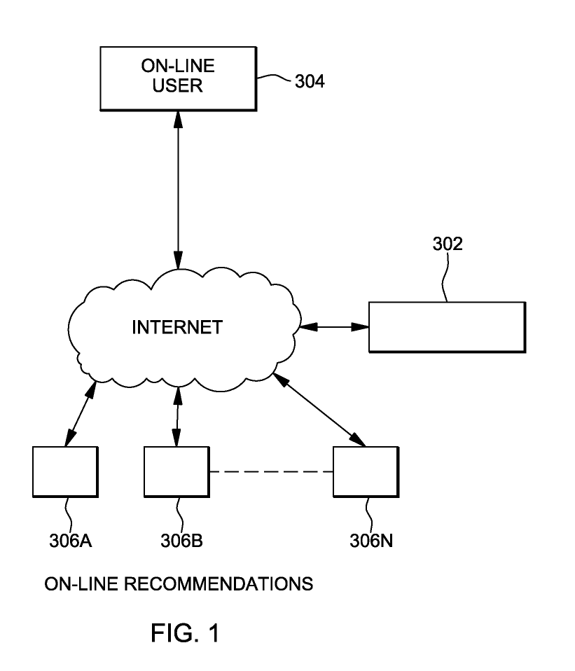

Referring to FIG. 1, a service web server 302 adapted to implement usage recommendations for on-line users, is coupled, via the internet, and programmed to capture various profile information (e.g., traits) of an on-line user(s) 304. For purposes of example, profile information is described for on-line users such as, for example, user(s) who read books on-line, in the case of the example on-line “book” usage recommendation. The profile information captured, in this non-limiting example, may include the types of books the on-line reader likes to read (e.g., subject matter, fiction, non-fiction), the age of the reader, the number of books read in the last six months. The server also captures, via the internet, usage data about the on-line books, e.g., the viewing or reading behavior of that user on-line. For example, in the case of a group of on-line readers, the server captures on-line user's viewing or reading behavior, such behavior captured may include but is not limited to: how the user reads the on-line book, (e.g., traverse over content, skip over chapters or navigates to certain chapters in a certain order, re-reads certain chapters, view or skim images, etc. This information is gathered and built over time, such that, the usage information for that item, e.g., an on-line book, is based on similar users, e.g., on-line book readers, having similar profiles. The server 302 is also coupled, via the internet, and provisioned to capture usage information, e.g., which can be used to infer a rating, about various book(s) from several readers or groups of readers 306A, 306B . . . 306N having profiles similar to the profile of the on-line reader. The on-line usage information received by server 302 is captured, stored and processed to provide usage recommendations that can be presented to the current or subsequent on-line reader(s).

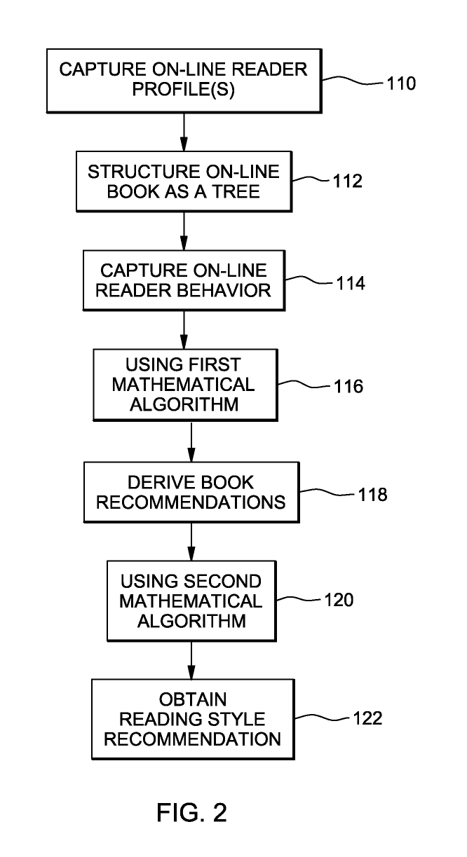

FIG. 2 is a flow chart showing the method of providing a usage recommendation of at least one item, e.g., an on-line book, to an on-line user based on profile information, e.g., similarity of preferences of the user and preferences indicated in profiles of other users. Particularly, FIG. 2 depicts the processing performed by a processing apparatus which may, for example, be provided embodied as web server 302 of FIG. 1 defining an on-line media recommending system based on usage analysis for providing online user recommendations, e.g., where the user is an online reader. In an embodiment, an online reader's profile, e.g., personal reading habits, are collected, stored and considered according to the invention. For example, the online reader's profile can include the type of books read such as histories, sports, science fiction, travel, etc.; the media format (hardcover, paperback, electronic, etc.); the age of the online reader; the gender of the online reader; the number of books read in the last six months, etc. Other example information that can be captured that relates to the online reader's profile can be whether a book was actually read after it was purchased. This may provide an indication of how well the online reader liked the book. What sections of the book were referenced most often and what sections were referenced first. This information can indicate what information the online reader was seeking when purchasing the book. It is understood that, in other example embodiments, the profile information captured for online users can relate to that user's use of any service, product or media item (e.g., audio, video, multimedia data items having other attributes) that can be accessed on line that may be subject to ratings or user evaluations.

Answers to such information can be used to provide more insightful recommendations about other service, product or media item, e.g., books, that may be of potential interest to a current on-line user, and other subsequent on-line users accessing the web site. For example, such use information may make an online book purchaser more willing to purchase additional books recommended by the online book seller.

Referring to FIG. 2, there is a shown a flow chart of a method 100 for providing a recommendation of at least one item to an online user based on collected profile information. The methodology depicted in FIG. 2 is described herein in the context of online books, but a similar approach can be applied to other online media for which usage recommendations may be suggested, such as video, music, etc., with the inclusion of other product attributes. Initially, a profile of the online reader including usage data, is captured, block 110. The example scenario of online book reader's profile can include: the readers gender, age, number of books read in the past 6 months, type of books the reader is interested in reading such as, for example, travel, mystery, biographies, short stories, science, books about educational subjects such as astronomy, engineering, political science, and the like. Then, a selected book of interest is structured, within the server processing, as a tree structure, block 112 where the leaf nodes of the tree can represent each page of the book. The parent tree nodes can represent the chapters of the book, the grand-parent tree nodes can represent the title page of the book, etc. Content key words that may include, but are not limited to, author, category, etc. Key words are attached to the book tree structure where key words can be based on word frequency or other modifiers. In block 114, the online reader's behavior for each book selected and/or purchased, is captured. In one embodiment, the user's computing device includes utilities for monitoring a user's on-line reading behavior and forwarding information regarding user behavior for input to the user profile stored at the server device. Such utilities might be similar to capabilities used, e.g., to track advertising “click-through” on a Web site. See, for example, U.S. Pat. No. 6,401,075, “Methods of placing, purchasing and monitoring internet advertising”, Mason, James C., Grant, Behrman, Arnold, Stillwell, Dennis, June, 2002. The online reader's usage behavior characteristics detectable by the utilities implemented at the user client device and collected at the web server can include, but is not limited to: the time the online reader spends reading each page, the frequency or number of times that the online reader accesses various pages, the number of mouse clicks per page, scrolling bar pulling, page access sequence, etc.

Then, continuing to block 116, a first mathematical algorithm is applied to identify a similar group(s) of readers based on the prior profiles obtained and stored in step 110 above in addition to information including reading speed, reading frequency, reading style, etc. using historical data for previous books that were read. Possible mathematical algorithms can include but are not limited to cluster analysis or collaborative filtering.

The term cluster analysis encompasses a number of different algorithms and methods for grouping objects of a similar kind into respective categories. Cluster analysis is an exploratory data analysis tool which aims at sorting different objects into groups in a way that the degree of association between two objects is maximal if they belong to the same group and minimal if they do not belong to the same group. Cluster analysis can be used to discover structures in data without providing an explanation and/or an interpretation. Thus, cluster analysis simply discovers structures in data without explaining why they exist.

Collaborative Filtering (CF) is a method of making automatic predictions (filtering) about the interests of a user by collecting taste information from many users (collaborating). The underlying assumption of CF approach is that those who agreed in the past tend to agree again in the future. For example, collaborative filtering for music tastes can make predictions about which music a user should like given a partial list of that user's tastes (likes or dislikes). Note that these predictions are specific to the user, but use information is gleaned from many users.

Collaborative filtering is useful when the number of items in only one category (such as books) becomes so large that a single person cannot possibly view them all in order to select relevant books. Relying on a scoring or rating system which is averaged across all users ignores specific demands of a user, and is particularly poor in tasks where there is a large variation in interest, for example, in the recommendation of books. The paper of Breese, J. S. et al (1998) Empirical analysis of predictive algorithms for collaborative filtering. Proceedings of the Fourteenth Conference on Uncertainty in Artificial Intelligence, v 461, San Francisco, Calif. discusses a number of different predictive algorithms used for collaborative filtering.

Proceeding to block 118, usage data obtained from the previously identified similar group of readers is used to derive a book usage recommendation for a selected on-line book for the online reader. Such usage recommendation might be based, for example, on averaging the number of based on books read by other readers having similar profiles and book reading characteristics. A second mathematical algorithm is now used to identify a reason or an objective as to why the online reader is looking for a book based on the online reader's profile, reading speed, reading frequency, reading style, etc., using historical data obtained from previous on-line books read by others that are similar to the online reader's profile, block 120. A preferred second mathematical algorithms for determining the online reader's use can be, classification trees and support vector machines.

A classification tree (also known as decision tree) method is used when a data mining task is classification or prediction of outcomes and the goal is to generate rules that can be easily understood, explained, and translated into a natural query language. Classification tree labels are assigned to discrete classes. A classification tree is built through a process known as binary recursive partitioning. This is an iterative process of splitting data into partitions, and then splitting it up further on each of the branches. Initially, it starts with a training set in which the classification label (“purchaser” or “non-purchaser”) is known (pre-classified) for each record. All of the records in the training set are together in one group or part. The algorithm then systematically tries breaking up the records into two parts, examining one variable at a time and splitting the records on the basis of a dividing line in that variable (income>$55,000 or income <=$55,000). The object is to obtain a homogeneous set of labels (“purchaser” or “non-purchaser”) in each partition. The splitting or partitioning is then applied to each of the new partitions and the process continues until no more useful splits can be found.

The classification tree process starts with a training set consisting of pre-classified records. Pre-classified means that the target field, or dependent variable, has a known class or label, for example “purchaser” or “non-purchaser”. The goal is to build a tree that distinguishes among the classes. For simplicity if it is initially assumed that there are only two target classes and that each split is binary partitioning. The splitting criterion easily generalizes to multiple classes, and any multi-way partitioning can be achieved through repeated binary splits. To choose the best splitter at a node, the algorithm considers each input field in turn. In essence, each field is sorted. Then, every possible split is tried and considered, and the best split is the one which produces the largest decrease in diversity of the classification label within each partition (thus, the increase in homogeneity. This is repeated for all fields and the winner is chosen as the best splitter for that node. The process is continued at the next node and, in this manner, a full tree is generated.

Support vector machines assign labels to instances where the labels are drawn from a finite set of several elements to reduce a single multiclass problem into multiple binary problems. Each problem yields a binary classifier which is believed to produce an output function that gives relatively large values for examples from a positive class and relatively small values for examples belonging to a negative class. Two common methods to build such binary classifiers are where each classifier distinguishes between (A) one of the labels to the rest (one-versus-all) or (B) between every pair of classes (one-versus-one). Classification of new instances for one-versus-all case is done by winner takes-all strategy, in which the classifier with the highest output function assigns the class. The classification of one-versus-one case is done by max-wins voting strategy in which every classifier assigns the instance to one of the two classes, then the vote for the assigned class is increased by one vote. Finally the class with most votes determines the instance classification.

Returning to FIG. 2, block 122, a reading style (usage) recommendation is derived by mapping each identified online reader purpose to the structure of the book tree as defined in block 112.

Particularly, a third mathematical technique is implemented for deriving a reading style recommendation by using a third mathematical algorithm to determine a characteristic reading pattern for the previously identified similar book readers having similar reading objective. The reading pattern is represented through mapping of the reading pattern to the structure of said book tree. In one embodiment, the third mathematical algorithm includes sequence cluster analysis, or Hidden Markov modeling. For example, sequence clustering refers to the grouping of strings of characters based on some criteria, usually similarity in their sequence. Sequence clustering is a first step in several complex string-related computations, such as the construction of a search table. The procedure of sequence clustering includes following steps:
1) Compare a given sequence to a clustered sequence that has not yet been compared to the given sequence.
2) If the given sequence is similar to the “clustered” sequence, add the given sequence to the same “cluster” of sequences.
3) If there are still sequences to compare, then go to the first step.
4) If this point is reached, start a new “cluster” with this sequence.
5) If there are still sequences waiting to be clustered, choose one of these sequences and return to step 1.
6) If this step is reached, the clustering is finished.

The result includes several clusters of sequences, which are groupings of sequences that are very similar to one another.

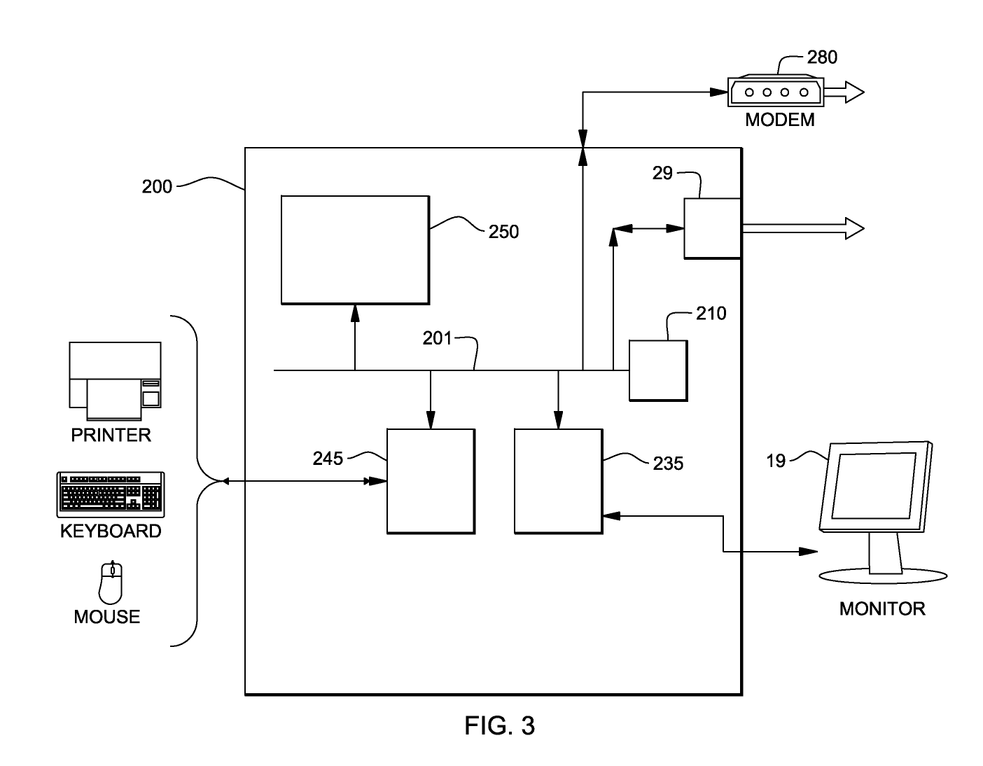

A computer-based system 200 is depicted in FIG. 3 herein by which the method of the present invention may be carried out. Computer system 200 includes a processing unit, which houses a processor, memory and other systems components that implement a general purpose processing system or computer that may execute a computer program product. The computer program product may comprise media, for example a compact storage medium such as a compact disc, which may be read by the processing unit through a disc drive, or by any means known to the skilled artisan for providing the computer program product to the general purpose processing system for execution thereby.

The computer program product comprises all the respective features enabling the implementation of the methods described herein, and which—when loaded in a computer system—is able to carry out these methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit (as mentioned) or may be located on a remote system such as a server (not shown), coupled to processing unit, via a network interface such as an Ethernet interface. Monitor, mouse and keyboard are coupled to the processing unit, to provide user interaction. Printer is shown coupled to the processing unit via a network connection, but may be coupled directly to the processing unit.

More specifically, as shown in FIG. 3, the computer system 200, includes one or more processors or processing units 210, a system memory 250, and an address/data bus structure 201 that connects various system components together. For instance, the bus 201 connects the processor 210 to the system memory 250. The bus 201 can be implemented using any kind of bus structure or combination of bus structures, including a memory bus or memory controller, a peripheral bus, an accelerated graphics port, and a processor or local bus using any of a variety of bus architectures such as ISA bus, an Enhanced ISA (EISA) bus, and a Peripheral Component Interconnects (PCI) bus or like bus device. Additionally, the computer system 200 includes one or more monitors 19 and, operator input devices such as a keyboard, and a pointing device (e.g., a “mouse”) for entering commands and information into computer, data storage devices, and implements an operating system such as Linux, various Unix, Macintosh, MS Windows OS, or others.

The computing system 200 additionally includes: computer readable media, including a variety of types of volatile and non-volatile media, each of which can be removable or non-removable. For example, system memory 250 includes computer readable media in the form of volatile memory, such as random access memory (RAM), and non-volatile memory, such as read only memory (ROM). The ROM may include an input/output system (BIOS) that contains the basic routines that help to transfer information between elements within computer device 200, such as during start-up. The RAM component typically contains data and/or program modules in a form that can be quickly accessed by processing unit. Other kinds of computer storage media include a hard disk drive (not shown) for reading from and writing to a non-removable, non-volatile magnetic media, a magnetic disk drive for reading from and writing to a removable, non-volatile magnetic disk (e.g., a “floppy disk”), and an optical disk drive for reading from and/or writing to a removable, non-volatile optical disk such as a CD-ROM, DVD-ROM, or other optical media. Any hard disk drive, magnetic disk drive, and optical disk drive would be connected to the system bus 201 by one or more data media interfaces (not shown). Alternatively, the hard disk drive, magnetic disk drive, and optical disk drive can be connected to the system bus 201 by a SCSI interface (not shown), or other coupling mechanism. Although not shown, the computer 200 can include other types of computer readable media. Generally, the above-identified computer readable media provide non-volatile storage of computer readable instructions, data structures, program modules, and other data for use by computer 200. For instance, the readable media can store an operating system (O/S), one or more application programs, such as video editing client software applications, and/or other program modules and program data for enabling video editing operations via Graphical User Interface (GUI), Input/output interfaces 245 are provided that couple the input devices to the processing unit 210. More generally, input devices can be coupled to the computer 200 through any kind of interface and bus structures, such as a parallel port, serial port, universal serial bus (USB) port, etc. The computer environment 500 also includes the display device 19 and a video adapter card 235 that couples the display device 19 to the bus 201. In addition to the display device 19, the computer environment 200 can include other output peripheral devices, such as speakers (not shown), a printer, etc. I/O interfaces 245 are used to couple these other output devices to the computer 200.

As mentioned, computer system 200 is adapted to operate in a networked environment using logical connections to one or more computers, such as a server device that may include all of the features discussed above with respect to computer device 200, or some subset thereof. It is understood that any type of network can be used to couple the computer system 200 with server device, such as a local area network (LAN), or a wide area network (WAN) (such as the Internet). When implemented in a LAN networking environment, the computer 500 connects to local network via a network interface or adapter 29. When implemented in a WAN networking environment, the computer 500 connects to a WAN via a high speed cable/dsl modem 280 or some other connection means. The cable/dsl modem 280 can be located internal or external to computer 200, and can be connected to the bus 201 via the I/O interfaces 245 or other appropriate coupling mechanism. Although not illustrated, the computing environment 200 can provide wireless communication functionality for connecting computer 200 with remote computing device, e.g., an application server (e.g., via modulated radio signals, modulated infrared signals, etc.).

Although an example of the present invention has been shown and described, it would be appreciated by those skilled in the art that changes might be made in the embodiment without departing from the principles and spirit of the invention, the scope of which is defined in the claims and their equivalents.

What is claimed is:

1. A computer-implemented method of providing online recommendations comprising:
capturing, for one or more users at a respective client device, usage characteristics of each users' navigation to and use of one or more items, from among a plurality of items of an item set, on-line, via a respective user interface;
obtaining corresponding profile information for each respective user, said profile information including user attributes;
storing said usage characteristics and corresponding profile information of each of one or more users; and, for a current user navigating online to said set of items:
deriving an item usage recommendation for said current online user based on items of said item set navigated to and used by other online users having similar profiles; and,
recommending for said current user, via that current user's user interface, an on-line item and its suggested usage from among said set of items, wherein a programmed processing unit performs one or more said capturing, obtaining and deriving.

2. The computer-implemented method of claim 1, wherein said current on-line user reads books, and said on-line item is a book, said deriving a recommendation includes:
structuring said book as a tree;
using a first mathematical algorithm for identifying similar book readers,
using a second mathematical algorithm to identify said on-line book reader's reading objective based on at least one characteristic of said on-line book reader; and
deriving a reading style recommendation by using a third mathematical algorithm to determine a characteristic reading pattern for the previously identified similar book readers having similar reading objective, where said reading pattern is represented through mapping of the reading pattern to the structure of said book tree.

3. The computer-implemented method of claim 2, wherein said profile of said online book reader includes type of books read in previous months.

4. The computer-implemented method of claim 2, wherein said first mathematical algorithm enables grouping of on-line book readers having profiles similar to the profile of said online book reader.

5. The computer-implemented method of claim 3, wherein nodes of said tree represents parts of said book.

6. The computer-implemented method of claim 5, further comprising:
attaching at least one content key word to the book tree wherein said at least one content key word is author or category.

7. The computer-implemented method of claim 6, wherein said key word is based on frequency of use.

8. The computer-implemented method of claim 4, wherein said first mathematical algorithm includes cluster analysis or collaborative filtering.

9. The computer-implemented method of claim 7, further comprising:
deriving a book reading pattern recommendation for said online book reader based on reading patterns of books read by other readers with profiles similar to said current online reader.

10. The computer-implemented method claim 8, wherein said second mathematical algorithm includes classification trees, or support vector machines.

11. The computer-implemented method of claim 10, wherein historical data of previous books read by others similar to said online book reader is used with said second mathematical algorithm to identify said online book reader's purpose.

12. The computer-implemented method of claim 8 wherein said third mathematical algorithm includes sequence cluster analysis, or Hidden Markov modeling.

13. A system for providing online recommendations comprising:
a memory;
a processor in communications with the memory, wherein the computer system performs a method comprising:
capturing, for one or more users at a respective client device, usage characteristics of each users' navigation to and use of one or more items, from among a plurality of items of an item set, on-line, via a respective user interface;
obtaining corresponding profile information for each respective user, said profile information including user attributes;
storing said usage characteristics and corresponding profile information of each of one or more users; and, for a current user navigating online to said set of items:
deriving an item usage recommendation for said current online user based on items of said item set navigated to and used by other online users having similar profiles; and,
recommending for said current user, via that current user's user interface, an on-line item and its suggested usage from among said set of items, wherein a programmed processing unit performs one or more said capturing, obtaining and deriving.

14. The system of claim 13, wherein said current on-line user reads books, and said on-line item is a book, said deriving a recommendation includes:
structuring said book as a tree;
using a first mathematical algorithm for identifying similar book readers,
using a second mathematical algorithm to identify said on-line book reader's reading objective based on at least one characteristic of said on-line book reader; and
deriving a reading style recommendation by using a third mathematical algorithm to determine a characteristic reading pattern for the previously identified similar book readers having similar reading objective, where said reading pattern is represented through mapping of the reading pattern to the structure of said book tree.

15. The system of claim 14, wherein said profile of said online book reader includes type of books read in previous months.

16. The system of claim 14, wherein said first mathematical algorithm enables grouping of on-line book readers having profiles similar to the profile of said online book reader.

17. The system of claim 15, wherein nodes of said tree represents parts of said book.

18. The system of claim 17, wherein said method further comprises:
attaching at least one content key word to the book tree wherein said at least one content key word is author or category.

19. The system of claim 18, wherein said key word is based on frequency of use.

20. The system of claim 16, wherein said first mathematical algorithm includes cluster analysis or collaborative filtering.

21. The system of claim 19, wherein said method further comprises:
deriving a book reading pattern recommendation for said online book reader based on reading patterns of books read by other readers with profiles similar to said current online reader.

22. The system claim 20, wherein said second mathematical algorithm includes classification trees, or support vector machines.

23. The system of claim 22, wherein historical data of previous books read by others similar to said online book reader is used with said second mathematical algorithm to identify said online book reader's purpose.

24. The method of claim 14, wherein said third mathematical algorithm includes sequence cluster analysis, or Hidden Markov modeling.

25. A computer program product for providing online recommendations, the computer program product comprising:
a storage medium readable by a processing circuit and storing instructions for execution by the processing circuit for performing a method comprising:
capturing, for one or more users at a respective client device, usage characteristics of each users' navigation to and use of one or more items, from among a plurality of items of an item set, on-line, via a respective user interface;
obtaining corresponding profile information for each respective user, said profile information including user attributes;
storing said usage characteristics and corresponding profile information of each of one or more users; and, for a current user navigating online to said set of items:
deriving an item usage recommendation for said current online user based on items of said item set navigated to and used by other online users having similar profiles; and,
recommending for said current user, via that current user's user interface, an on-line item and its suggested usage from among said set of items, wherein a programmed processing unit performs one or more said capturing, obtaining and deriving.

26. The computer program product of claim 25, wherein said current on-line user reads books, and said on-line item is a book, said deriving a recommendation includes:
structuring said book as a tree;
using a first mathematical algorithm for identifying similar book readers,
using a second mathematical algorithm to identify said on-line book reader's reading objective based on at least one characteristic of said on-line book reader; and
deriving a reading style recommendation by using a third mathematical algorithm to determine a characteristic reading pattern for the previously identified similar book readers having similar reading objective, where said reading pattern is represented through mapping of the reading pattern to the structure of said book tree.
